(19) United States
(12) Patent Application Publication
(10) Pub. No.: US 2009/0070001 A1
(43) Pub. Date: Mar. 12, 2009

(54) CONTROLLER FOR HYBRID VEHICLE

(75) Inventors: Shinsuke Takakura, Kawasaki-city (JP); Yasuo Kato, Niwa-gun (JP); Masao Kano, Gamagori-city (JP); Yuusaku Nishimura, Toyota-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); TOYOTA JIDOSHA KABUSHIKI KAISHA, Toyota-city (JP)

(21) Appl. No.: 12/202,474

(22) Filed: Sep. 2, 2008

(30) Foreign Application Priority Data
Sep. 10, 2007 (JP) 2007-234035

(51) Int. Cl. F02D 45/00

(52) U.S. Cl. 701/102; 290/7; 290/1 A; 123/520

(57) ABSTRACT

A fuel vapor treatment apparatus includes: a detection passage provided with a restrictor therein; a pump generating a gas-flow in the detection passage; and a differential pressure sensor detecting a pressure loss at the restrictor. A fuel vapor concentration is computed based on a pressure loss when air passes through the detection passage and a pressure loss when an air-fuel mixture passes through the detection passage. When the computed fuel vapor concentration reaches a specified value, an internal combustion engine is started and the fuel vapor treatment apparatus starts to supply the fuel vapor adsorbed by the canister to the internal combustion engine.

### CROSS-REFERENCE TO RELATED APPLICATION

This application is based on Japanese Patent Application No. 2007-234035 filed on Sep. 10, 2007, the disclosure of which is incorporated herein by reference.

### FIELD OF THE INVENTION

The present invention relates to a controller for a hybrid vehicle provided with a fuel vapor treatment apparatus.

### BACKGROUND OF THE INVENTION

There has been conventionally known a fuel vapor treatment apparatus that causes a canister to temporarily adsorb fuel vapor produced in a fuel tank and introduces the fuel vapor desorbed from the canister through a purge passage into an intake passage of an internal combustion engine to purge the fuel vapor.

JP-2002-221064A (U.S. Pat. No. 6,664,651B1) shows a hybrid vehicle on which a fuel vapor treatment apparatus is mounted. A fuel vapor adsorbing state of the canister is estimated based on an internal pressure of the fuel tank, an elapsed time after a previous purge, and a previous purged fuel vapor quantity. When it is determined that a fuel vapor purge is necessary, the internal combustion engine is started to perform the fuel vapor purge.

JP-6-101534A shows a fuel vapor treatment apparatus which is mounted on a gasoline engine. In this fuel vapor treatment apparatus, a fuel vapor concentration in a purge passage is detected to correctly estimate a fuel vapor adsorbing state of the canister.

The quantity of the evaporated fuel and the quantity of the fuel vapor desorbed from the canister vary according to a volatility of the fuel and a vehicle driving condition. Hence, the method of estimating the fuel vapor adsorbing condition shown in JP-2002-221064A (U.S. Pat. No. 6,664,651B1) lacks an accuracy of estimation. The fuel vapor adsorbing state of the canister may be erroneously determined to start the engine, which may deteriorate the fuel economy.

In the method of detecting fuel vapor concentration shown in JP-6-101534A, the concentration can not be detected if the purged gas does not flow in the purge passage. That is, when the engine is stopped, the fuel vapor concentration can not be detected.

### SUMMARY OF THE INVENTION

The present invention is made in view of the above matters, and it is an object of the present invention to reduce a frequency of an engine operation for performing a purge processing in a hybrid vehicle provided with a fuel vapor treatment apparatus.

The present invention is applied to a hybrid vehicle provided with an electric motor and an internal combustion engine. A fuel vapor treatment apparatus includes: a detection passage provided with an restrictor therein; a gas-flow producing means for decompressing an interior of the detection passage to generate a gas-flow therein; a detection passage switching means for switching the detection passage between a first state where the detection passage communicates to atmosphere to introduce air therein and a second state where the detection passage communicates to the canister to introduce the air-fuel mixture therein; a pressure detecting means for detecting a pressure determined by the restrictor and the gas flow producing means; and a concentration computing means for computing a fuel vapor concentration of the air-fuel mixture based on a detected pressure in the first state and a detected pressure in the second state.

When the fuel vapor concentration computed by the concentration computing means reaches a specified value, the engine control means starts the internal combustion engine and commands the fuel vapor treatment apparatus to supply the fuel vapor adsorbed by the canister to the internal combustion engine.

As long as the capacity of the gas flow producing means is constant, according to the energy conservation law, the flow velocity is different between the air passing through the detection passage and the gas passing the first detection passage due to a difference in density thereof. Since the density and the fuel vapor concentration have a relation, the flow velocity is varied according to the fuel vapor concentration.

The flow velocity defines a pressure loss at the restrictor. Hence, the fuel vapor concentration of the air-fuel mixture is correctly detected based on a detected pressure in the first state and a detected pressure in the second state. That is, even when the engine is stopped, the fuel vapor concentration can be correctly detected. Therefore, a frequency of the engine operation for performing the purge processing can be reduced in the hybrid vehicle, whereby the fuel economy is improved.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of the hybrid vehicle on which, the controller of the present invention is mounted;

FIG. 2 is a schematic view showing an internal combustion engine and a controller for a hybrid vehicle according to an embodiment of the present invention;

FIG. 3 is a characteristic graph for describing the principle of the present invention;

FIG, 4 is a flow chart for describing the main operation of the controller according to the embodiment;

FIG. 5 is a schematic diagram for describing the main operation and a first canister opening operation of the controller according to the embodiment;

FIG. 6 is a schematic diagram for describing the first canister opening operation of the controller according to the embodiment;

FIG. 7 is a characteristic graph for describing concentration measurement processing in FIG. 4;

FIG. 8 is a flow chart for describing the concentration measurement processing in FIG. 4;

FIG. 9 is a schematic diagram for describing the concentration measurement processing in FIG. 4;

FIG. 10 is a characteristic graph for describing the concentration measurement processing in FIG. 4;

FIG. 11 is a schematic diagram for describing the concentration measurement processing in FIG. 4;

FIG. 12 is a schematic diagram for describing the concentration measurement processing in FIG. 4;

FIG. 13 is a flow chart for describing purge processing in FIG. 4;

FIG. 14 is a schematic diagram for describing the purge processing in FIG. 4; and

FIG. 15 is a schematic diagram for describing the purge processing in FIG. 4.

### DETAILED DESCRIPTION OF EMBODIMENTS

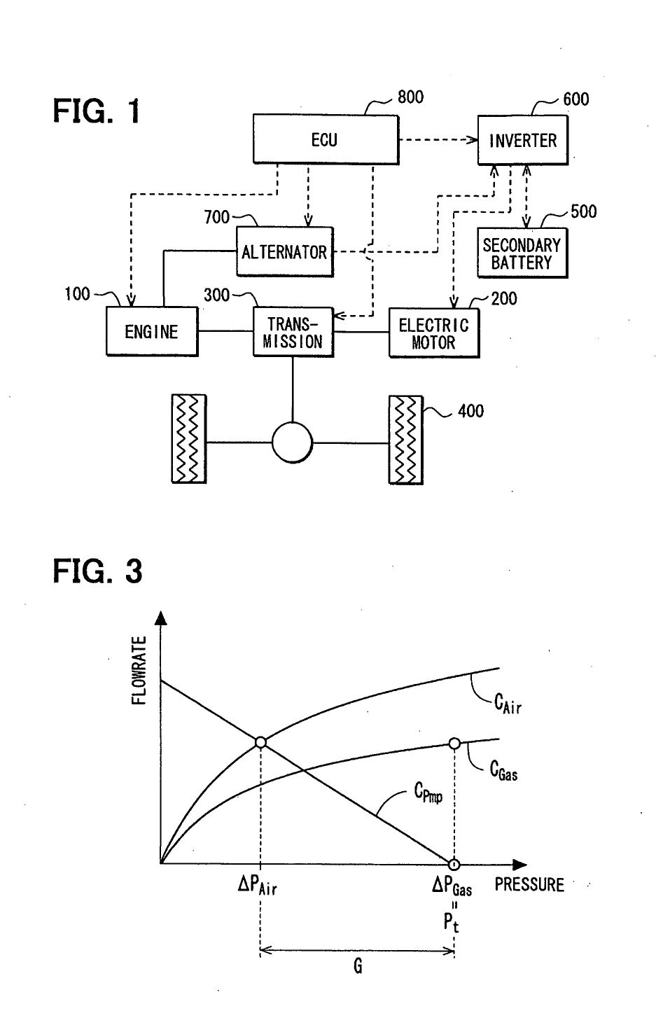

Hereafter, a first embodiment of the present invention is described. FIG. 1 is a schematic view of the hybrid vehicle on which the controller of the present invention is mounted.

As shown in FIG. 1, the hybrid vehicle is provided with an internal combustion engine 100 and an electric motor 200 for driving the vehicle. The driving force is transmitted to drive wheels 400 through a transmission 300. The electric motor 200 receives electricity from a secondary battery 500 through an inverter 600. The inverter 600 converts direct-current voltage into alternating-current voltage and varies frequency of the alternating-current voltage so that the rotational speed of the motor 200 is controlled.

An alternator 700 driven by the engine 100 generates electricity when the amount of charge of the battery 500 is lowered than a specified value. The electricity generated by the alternator 700 is supplied to the battery 500 through the inverter 600 so that the battery is charged.

Furthermore, the hybrid vehicle is provide with an electronic control unit (ECU) 800 which controls the engine 100, the transmission 300, the inverter 600, the alternator 700, and a fuel vapor treatment apparatus. The ECU 800 is mainly constructed of a microcomputer having a CPU, a ROM and a RAM.

The hybrid vehicle is driven in a plurality of driving modes. That is, the hybrid vehicle is driven in an engine driving mode where only the engine 100 is a driving source, a motor driving mode where only the motor 200 is the driving source, and a hybrid driving mode where both the engine 100 and the motor 200 are the driving source.

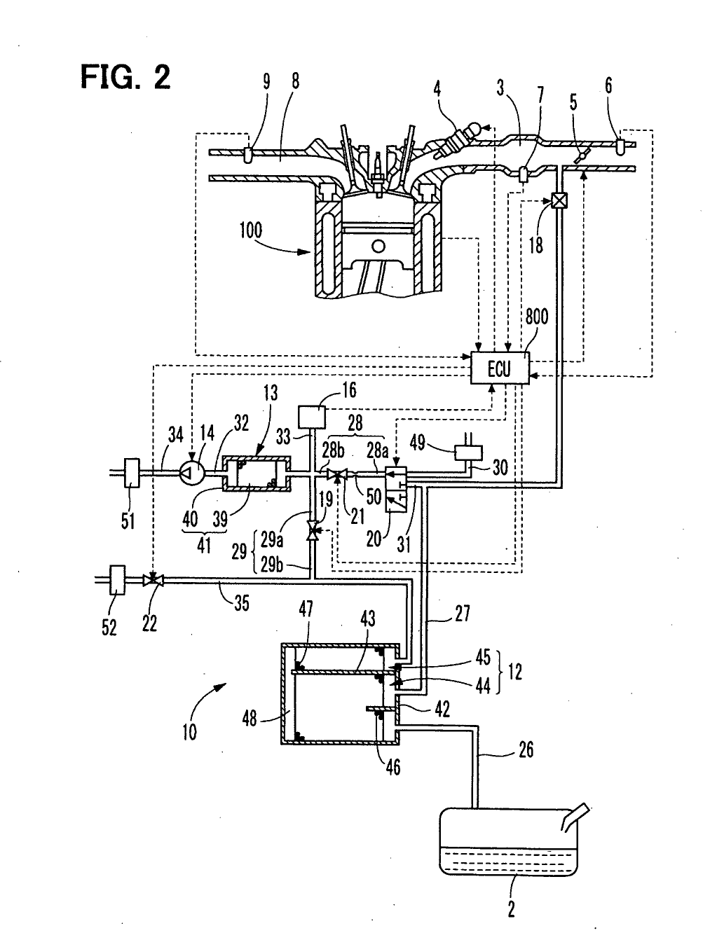

FIG. 2 shows an internal combustion engine 100 and a controller for a hybrid vehicle. The engine 100 is a gasoline engine that develops power by the use of gasoline fuel received in a fuel tank 2. The intake passage 3 of the engine 100 is provided with, for example, a fuel injection device 4 for controlling the quantity of fuel injection, a throttle device 5 for controlling the quantity of intake air, an air flow sensor 6 for detecting the quantity of intake air, an intake pressure sensor 7 for detecting an intake pressure, and the like. Moreover, the discharge passage 8 of the engine 100 is provided with, for example, an air-fuel ratio sensor 9 for detecting an air-fuel ratio.

The controller for a hybrid vehicle includes the ECU 800 and a fuel vapor treatment apparatus 10. The fuel vapor treatment apparatus 10 processes fuel vapor produced in the fuel tank 2 and supplies the fuel vapor to the engine 100. The fuel vapor treatment apparatus 10 is provided with a plurality of canisters 12 and 13, a pump 14, a differential pressure sensor 16, a plurality of valves 18 to 22, and a plurality of passages 26 to 35.

In the first canister 12, a case 42 is partitioned by a partition wall 43 to form two adsorption parts 44, 45. The respective adsorption parts 44, 45 are packed with adsorptive agents 46, 47 made of activated carbon or the like. The main adsorption part 44 is provided with an introduction passage 26 connecting with the inside of the fuel tank 2. Hence, fuel vapor produced in the fuel tank 2 flows into the main adsorption part 44 through the introduction passage 26 and is adsorbed by the adsorptive agent 46 in the main adsorption part 44 in such a way as to be desorbed. The main adsorption part 44 is further provided with a purge passage 27 connecting with the intake passage 3. A purge-controlling valve 18 made of an electromagnetically driven two-way valve is provided at the end of the intake passage side of the purge passage 27. The purge-controlling valve 18 is opened/closed to control the connection between the purge passage 27 and the intake passage 3. With this, in a state where the purge controlling valve 18 is opened, negative pressure developed on the downstream side of the throttle device 5 of the intake passage 3 is applied to the main adsorption part 44 through the purge passage 27. Therefore, when the negative pressure is applied to the main adsorption part 44, fuel vapor is desorbed from the adsorptive agent 46 in the main adsorption part 44 and the desorbed fuel vapor is mixed with air and is introduced into the purge passage 27, whereby fuel vapor in the air-fuel mixture is purged to the intake passage 3. The fuel vapor purged into the intake passage 3 through the purge passage 27 is combusted in the engine 100 along with fuel injected from the fuel injection device 4.

The main adsorption part 44 connects with a subordinate adsorption part 45 via a space 48 at the inside bottom of the case 42. A transit passage 29 connecting with the middle portion of a first detection passage 28 connects with the subordinate adsorption part 45. A connection-controlling valve 19 made of an electromagnetically driven two-way valve is provided in the middle portion of the transit passage 29. The connection-controlling valve 19 is opened or closed to control the connection between a portion 29a closer to the first detection passage 28 than the connection controlling valve 19 of the transit passage 29 and a portion 29b closer to the subordinate adsorption part 45 than the connection controlling valve 19. With this, in a state where the connection controlling valve 19 and the purge controlling valve 18 are opened, negative pressure in the intake passage 3 is applied to the subordinate adsorption part 45 through the purge passage 27, the main adsorption part 44, and the space 48 and also to the transit passage 29 and the first detection passage 28. Therefore, when the negative pressure is applied to the subordinate adsorption part 45 in a state where an air-fuel mixture exists in the first detection passage 28, the air-fuel mixture in the first detection passage 28 flows into the subordinate adsorption part 45 through the transit passage 29, whereby fuel vapor in the air-fuel mixture is adsorbed by the adsorptive agent 47 in the subordinate adsorption part 45 in such a way as to be desorbed. Moreover, when the negative pressure is applied to the subordinate adsorption part 45, the fuel vapor is desorbed from the adsorptive agent 47 in the subordinate adsorption part 45 and the desorbed fuel vapor remains once in the space 48 and then is adsorbed by the adsorptive agent 46 in the main adsorption part 44.

A passage-switching valve 20 is constructed of an electromagnetically driven three-way valve that performs a two-position action. The passage-switching valve 20 is connected to a first atmosphere passage 30 open to the atmosphere via a filter 49. Moreover, the passage-switching valve 20 is connected to a branch passage 31 branched from the purge passage 27 between the main adsorption part 44 and the purge controlling valve 18. Further, the passage-switching valve 20 is connected to one end of the first detection passage 28. The passage-switching valve 20 connected in this manner switches a passage connecting with the first detection passage 28 between the first atmosphere passage 30 and the branch passage 31 of the purge passage 27. Therefore, in a first state where the first atmosphere passage 30 connects with the first detection passage 28, air can flow into the first detection passage 28 through the first atmosphere passage 30. Moreover, in a second state where the branch passage 31 connects with the first detection passage 28, the air-fuel mixture containing the fuel vapor in the purge passage 27 can flow into the first detection passage 28 through the branch passage 31.

The pump 14, which is a gas flow generating means, is constructed of, for example, an electrically driven vane pump. The suction port of the pump 14 connects with one end of a second detection passage 32 and the discharge port of the pump 14 connects with a second atmosphere passage 34 open to the atmosphere via a filter 51. The pump 14 is so constructed as to reduce pressure in the second detection passage 32 and discharges gas auctioned from the second detection passage 32 to the second atmosphere passage 34 at the time of reducing the pressure.

A second canister 13 has an adsorption part 41 of a case 40 packed with an adsorptive agent 39 made of activated carbon or the like. The adsorption part 41 has the end opposite to the passage-switching valve 20 across the restrictor 50 of the first detection passage 28 and the end opposite to the pump 14 of the second detection passage 32 connected thereto at two positions across the adsorptive agent 39. Hence, when the pump 14 is operated in a state where the air-fuel mixture exists in the first detection passage 28, the air-fuel mixture in the first detection passage 28 flows into the adsorption part 41 and fuel vapor in the air-fuel mixture is adsorbed by the adsorptive agent 39 in the adsorption part 41 in such a way to be desorbed. At this time, in this embodiment, the capacity of the adsorptive agent 39 is set in such a way as to prevent the fuel vapor adsorbed by the adsorptive agent 39 from being desorbed. When negative pressure in the intake passage 3 is applied to the first detection passage 28, air flows from the second atmosphere passage 34 to the pump 14, whereby the fuel vapor is desorbed from the adsorptive agent 39. In this embodiment, two portions 29a and 29b across the connection-controlling valve 19 connect with each other in the transit passage 29 and hence the negative pressure in the intake passage 3 is applied to the first detection passage 28. Therefore, the fuel vapor desorbed from the adsorptive agent 39 flows into the subordinate adsorption part 45 through the transit passage 29 and is adsorbed by the adsorptive agent 47.

A restrictor 50 for restricting the passage area of the first detection passage 28 is formed in the middle portion between the connection portion of the transit passage 29 and the passage-switching valve 20 in the first detection passage 28. Moreover, a passage opening/closing valve 21 made of an electromagnetically driven two-way valve is provided in the middle portion between the connection portion of the transit passage 29 and the restrictor 50 in the first detection passage 28. The passage opening/closing valve 21 is opened or closed to control the connection between a portion 28a closer to the passage-switching valve 20 than the valve 21 of the first detection passage 28 and a portion 28b closer to the second canister 13 than the valve 21. When the portion 28a does not connect with the portion 28b, the first detection passage 28 is brought into a closed state between the passage-switching valve 20 connecting with the passages 30, 31 and the second canister 13, whereas when the portions 28a connects with the portion 28b, the first detection passage 28 is brought into an open state. That is, the passage opening/closing valve 21 opens or closes the first detection passage 28 in a portion closer to the second canister 13 than the passages 30, 31, to be more specific, between the second canister 13 and the restrictor 50.

The differential pressure sensor 16 connects with a pressure introducing passage 33 branched from the first detection passage 28 between the second canister 13 and the passage opening/closing valve 21. With this, the differential pressure sensor 16 detects a pressure difference between pressure that it receives through the pressure introducing passage 33 from a portion closer to the second canister 13 than the restrictor 50 of the first detection passage 28 and the atmospheric pressure. Therefore, a pressure difference detected by the differential pressure sensor 16 when the pump 14 is operated is substantially equal to the pressure difference between both ends of the restrictor 50 in a state where the passage opening/closing valve 21 is opened. Moreover, in a state where the passage opening/closing valve 21 is closed, the first detection passage 28 is closed on the suction side of the pump 14 and hence a pressure difference detected by the differential pressure sensor 16 when the pump 14 is operated is substantially equal to the shutoff pressure of the pump 14.

A canister closing valve 22 is constructed of an electromagnetically driven two-way valve and is provided in the middle portion in a third atmosphere passage 35 branched from the transit passage 29 between the connection controlling valve 19 and the subordinate adsorption part 45. An end opposite to the transit passage 29 across the canister-closing valve 22 of the third atmosphere passage 35 is open to the atmosphere via a filter 52. Therefore, in a state where the canister-closing valve 22 is opened, the subordinate adsorption part 45 is open to the atmosphere through the third atmosphere passage 35 and the transit passage 29.

The ECU 800 is electrically connected to the pump 14, the differential pressure sensor 16, and the valves 18 to 22 of the fuel vapor treatment apparatus 10 and the respective elements 4 to 7 and 9 of the engine 100. The ECU 800 controls the respective operations of the pump 14 and the valves 18 to 22 on the basis of the detection results of the respective sensors 16, 6, 7, 9, the temperature of cooling water of the engine 100, the temperature of working oil of the vehicle, the number of revolutions of the engine 100, the accelerator position of the vehicle, the ON/OFF state of an ignition switch, and the like.

When the ignition switch is ON, the engine 100 and/or the electric motor 200 can drive the vehicle. When the ignition switch is OFF, the operations of the engine 100 and the electric motor 200 are prohibited.

Referring to FIG. 4, a main operation of the controller for a hybrid vehicle will be described. The main operation is started when the ignition switch is turned ON. In step S101, the ECU 800 determines whether a first preset time has elapsed after a previous concentration measurement, which is performed in step S102, or after a previous concentration estimation, which is performed in step S107, in order to determine whether the fuel vapor concentration measurement should be started.

When the previous concentration measurement value or the previous concentration estimation value is small, the first preset time is set longer. When the previous concentration measurement value or the previous concentration estimation value is larger, the first preset time is set shorter. Thereby, a frequency of the concentration measurement is reduced and the concentration measurement can be conducted before the fuel vapor quantity adsorbed by the first canister 12 becomes 100% relative to an adsorbing capacity of the first canister 12. The relationship between the first preset time and the previous concentration measurement value or the previous concentration estimation value is stored in the memory of the ECU 800.

When it is determined that step S101 is affirmative, the routine proceeds to step S102 where fuel vapor concentration measurement processing is performed. When the concentration of fuel vapor in the purge passage 27 is measured by this concentration measurement processing in a state where the purge controlling valve 18 is closed, the routine proceeds to step S103 where the ECU 800 determines whether the fuel vapor concentration is greater than or equal to a specified concentration value. The specified concentration value in step S103 corresponds to the concentration of the fuel vapor which is required to be purged. This specified concentration value is stored in the memory of the ECU 800.

When the answer is No in step S103, the procedure returns to step S101. When the answer is Yes in step S103, the procedure proceeds to step S104 in which the ECU 800 determines whether the engine 100 is being operated.

When the answer is No, that is, when it is in the motor driving mode, the procedure proceeds to step S105 in which the engine 100 is started. After the engine 100 is started, the procedure proceeds to step S106 in which the ECU 800 determines whether a purge condition is established. When the answer is Yes in step S104, the procedure proceeds to step S106.

The purge condition is established when the coolant temperature of the engine 100 exceeds a specified value to complete warming-up of the engine 100 and the engine speed exceeds an idling speed. This purge condition is stored in the memory of the ECU 800.

When the answer is Yes in step S106, the procedure proceeds to step S107 in which the purge processing is performed. In the purge processing, the purge controlling valve 18 is opened to purge the fuel vapor from the purge passage 27 into the intake passage 3. In step S107, a present fuel vapor concentration is estimated based on the quantity of the fuel vapor which is purged in the purge processing. The estimated fuel vapor concentration is stored in the memory of the ECU 800. Steps S103, S105 and S107 correspond to an engine control means of the present invention.

While the purge processing is performed in step 107, if a purge stop condition is satisfied, the procedure returns to step S101. The purge stop condition is satisfied when an opening degree of an accelerator becomes lower than a predetermined value. Specifically, when the throttle valve is fully closed, the purge stop condition is satisfied. This purge stop condition is stored in the memory of the ECU 800. When the answer is No is step S106, the procedure proceeds to step S108. In step S108, the ECU 800 determines whether a second preset time has elapsed after the fuel vapor concentration measurement processing in step S102 is finished. When Yes in step S108, the procedure returns to step S101. When No in step S108, the procedure returns to step S106. The second preset time is set in consideration of the variation in fuel vapor concentration and a required accuracy of the concentration. This second preset time is stored in the memory of the ECU 800.

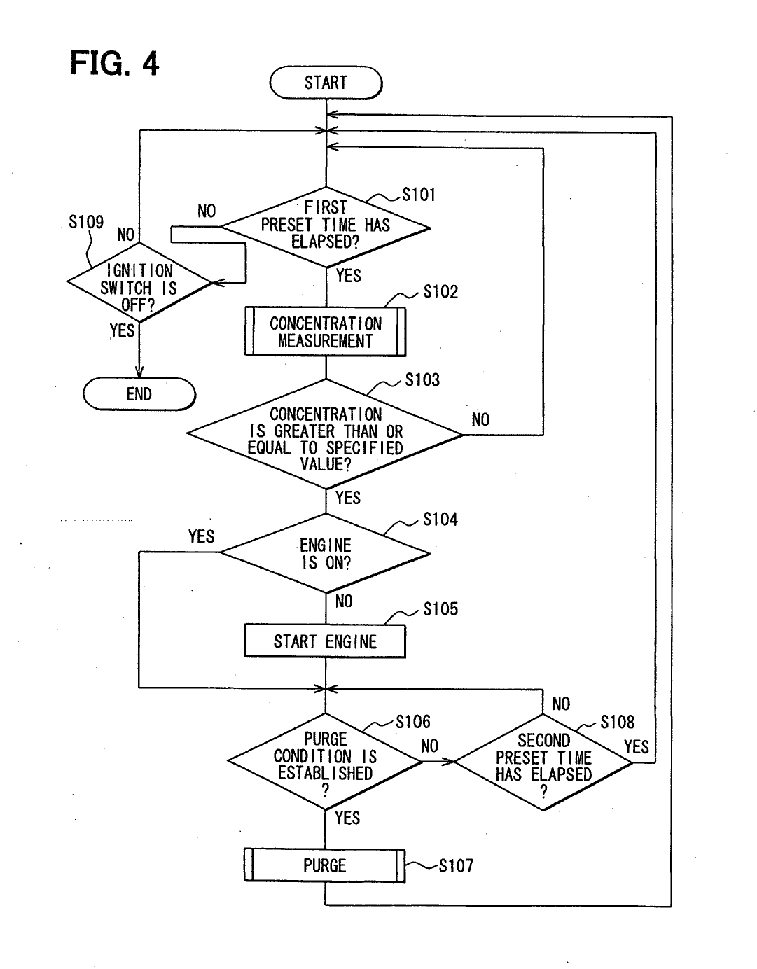

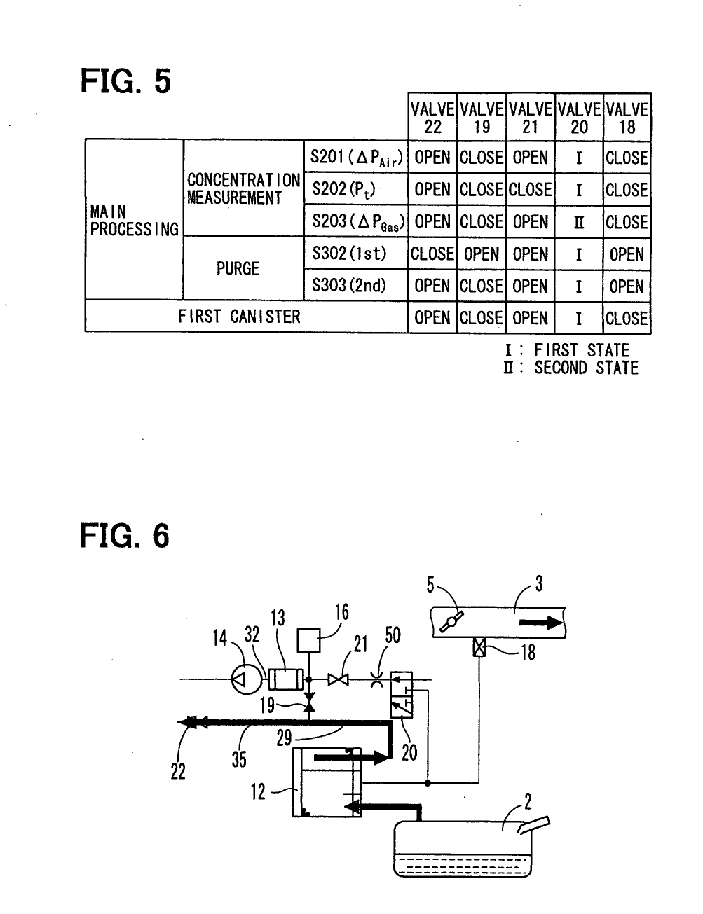

While following processing steps S102 to S108 when it is determined that step S101 is affirmative has been described, following processing step S109 when it is determined that step S101 is negative will be described. In step S109, it is determined by the ECU 800 whether or not the ignition switch is turned off. When it is determined that this step S109 is negative, the routine returns to step S101. Meanwhile, when it is determined that this step S109 is affirmative, the main operation is finished. In the fuel vapor treatment apparatus 10, after the main operation is finished, a first canister opening operation that brings the respective valves 18 to 22 to the states shown in FIG. 5 to open the first canister 12 to the atmosphere as shown in FIG. 6 is performed.

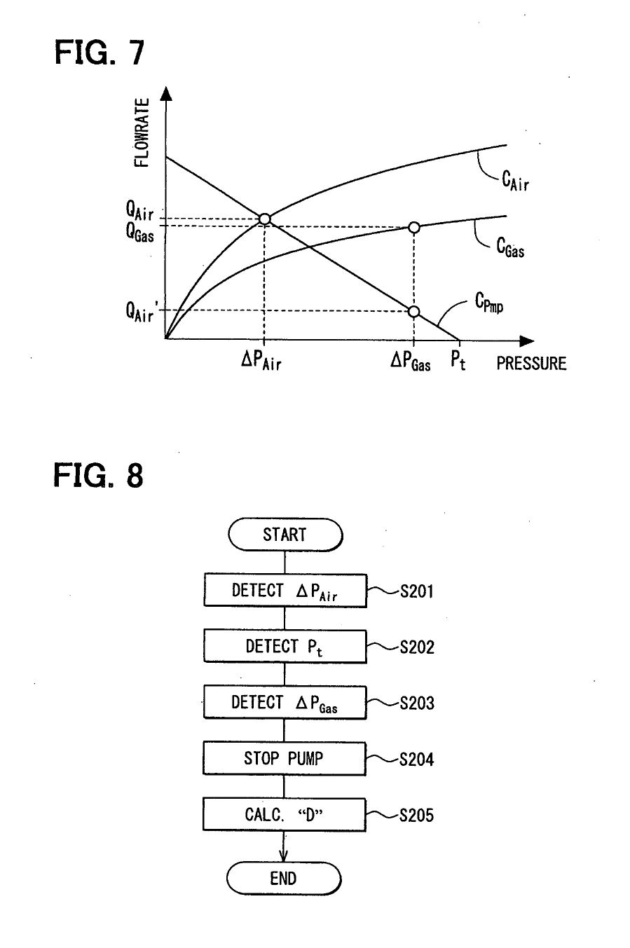

The above-mentioned concentration measurement processing in step S102 will be described in more detail. First, the measurement principle of the concentration of fuel vapor in the fuel vapor treatment apparatus 10 will be described. For example, in the case of the pump 14 having internal leak such as a vane pump, the quantity of internal leak varies according to load and hence, as shown in FIG. 7, the pressure (P)-flow rate (Q) characteristic curve Cpmp of the pump 14 is expressed by a following equation (1). In the equation (1), K1 and K2 are constants specific to the pump 14.

Q=K1×P+K2 (1)

Here, assuming that the shutoff pressure of the pump 14 is Pt, when the suction side of the pump 14 is shut off, that is, P=Pt, Q=0 and hence the following equation (2) is obtained.

i K2=−K1×Pt (2)

In the fuel vapor treatment apparatus 10, the pressure loss of flowing gas is reduced to as small a quantity as can be neglected on a side closer to the second canister 13 than the restrictor 50 of the first detection passage 28, the second canister 13, and the second detection passage 32. With this, in a state where the passage opening/closing valve 21 is opened, the pressure P of the pump 14 is thought to be substantially equal to a pressure difference ΔP between both ends of the restrictor 50 (hereinafter simply referred to as “pressure difference”). It is also possible to perform the following processing: when the pressure loss of flowing gas cannot be neglected in the second canister 13 and in the second detection passage 32, the pressure loss is previously stored in the ECU 800 and ΔP is corrected as required.

Moreover, when air passes through the restrictor 50 in a state where the passage opening/closing valve 21 is opened, the second canister 13 passes the air to the pump 14 and hence the flow rate of passage of air Q_{Air} is substantially equal to the flow rate Q of suction of air of the pump 14. Therefore, the flow rate Q_{Air} and the pressure difference ΔP_{Air} when air passes through the restrictor 50 satisfy the following relationship equation (3) obtained from the equations (1), (2).

Q_{Air}=K1×(ΔP_{Air}−Pt) (3)

Meanwhile, when the air-fuel mixture containing fuel vapor (hereinafter simply referred to as “air-fuel mixture”) passes through the restrictor 50 in a state where the passage opening/closing valve 21 is open, the second canister 13 passes only air and hence the flow rate of passage of air Q_{Air}′ in the air-fuel mixture is substantially equal to the flow rate of suction of air Q of the pump 14. Therefore, the flow rate of passage of air Q_{Air}′ in the air-fuel mixture and the pressure difference ΔP_{Gas} when the air-fuel mixture passes through the restrictor 50 satisfy the relationship of the following equation (4) obtained by the equations (1) and (2).

Q_{Air}′=K1×(ΔP_{Gas}−Pt) (4)

When it is assumed that the flow rate of passage of the whole air-mixture at the restrictor 50 is Q_{Gas} and the concentration of fuel vapor is D (%), the flow rate of passage of Q_{Air}′ in the air-fuel mixture satisfies the following equation (5). Hence, the following equation (6) can be obtained from this equation (5).

Q_{Air}′=Q_{Gas}×(1−D/100) (5)

D=100×(1−Q_{Air}′/Q_{Gas}) (6)

The pressure difference ΔP-flow rate Q characteristic curve of gas at the restrictor 50 is expressed by the following equation (7) using the density ρ of the gas passing through the restrictor 50. Here, K3 in the equation (7) is a constant specific to the restrictor 50 and is a value expressed by the following equation (8) when the diameter and the flow coefficient of the restrictor 50 are assumed to be d and α, respectively.

Q=K3×(ΔP/ρ)^{1/2} (7)

K3=α×π×d²/4×2^{1/2} (8)

Therefore, the ΔP-Q characteristic curve C_{Air} shown in FIG. 7 is expressed by the following equation (9) using the density ρ_{Air} of air.

Q_{Air}=K3×(ΔP_{Air}/ρ_{Air})^{1/2} (9)

Moreover, the ΔP-Q characteristic curve C_{Gas} of the air-fuel mixture shown in FIG. 7 is expressed by the following equation (10) by the use of the density ρ_{Gas} of the air-fuel mixture. Here, when it is assumed that the density of hydrocarbon (HC) of a component of the fuel vapor is ρ_{HC}, there is a relationship expressed by the following relationship equation (11) between the density ρ_{Gas} of the air-fuel mixture and the concentration D (%) of fuel vapor in the air-fuel mixture.

Q_{Gas}=K3×(ΔP_{Gas}/ρ_{Gas})^{1/2} (10)

D=100×(ρ_{Air}−ρ_{GaS})/(ρ_{Air}−ρ_{HC}) (11)

From the above-mentioned equations, by eliminating K1 from the equations (3) and (4), the following equation (12) is obtained. Moreover, by eliminating K3 from the equations (9) and (10), the following equation (13) is obtained.

Q_{Air}/Q_{Air}′=(ΔP_{Air}−Pt)/(ΔP_{GAS}−Pt) (12)

Q_{Air}/Q_{Gas}={(ΔP_{Air}/ΔP_{Gas})×(ρ_{Gas}/ρ_{Air})}^{1/2} (13)

Furthermore, by eliminating Q_{Air} from the equations (12) and (13), the following equation (14) is obtained, and the following equation (15) is obtained from the equation (11). Hence, the following equation (16) is obtained from these equations (14), (15), and (6). P1, P2, and ρ in the equation (16) are expressed by the following equations (17), (18), and (19).

Q_{Air}′/Q_{Gas}=(ΔP_{Gas}−Pt)/(ΔP_{Air}−Pt)×{(ΔP_{Air}/ΔP_{Gas}) ×(ρ_{Gas}/ρ_{Air})}^{1/2} (14)

ρ_{Gas}=ρ_{Air}−(ρ_{Air}−ρ_{HC})×D/100 (15)

D=100×[1−P1×{P2×(1−ρ×D}^{1/2}] (16)

P1=(ΔP_{Gas}−Pt)/(ΔP_{Air}−Pt) (17)

P2=ΔP_{Air}/ΔP_{GaS} (18)

ρ=(ρ_{Air}−ρ_{HC})/(100×ρ_{Air}) (19)

When both sides of the equation (16) are squared and rearranged for D, the following quadratic equation (20) is obtained. When this quadratic equation (20) is solved for D, the following solution (21) is obtained. M1 and M2 in the solution (21) are expressed by the following equations (22) and (23).

D²+100×(100×P1²×P2×ρ−2)×D+100²×(1−P1²×P2) (20)

D=50×{−M1±(M1²−4×M2)^{1/2}} (21)

M1=100×P1²×P2×ρ−2 (22)

M2=1−P1²×P2 (23)

Therefore, because a value beyond a range from 0 to 100 of the solutions (21) of the quadratic equation (20) does not hold as the concentration D of fuel vapor, a value within the range from 0 to 100 of the solutions (21) is obtained as the equation (24) of computing the concentration D of fuel vapor.

D=50×{−M1−(M1²−4×M2)^{1/2}} (24)

In the equation (24) of computing the concentration D of fuel vapor obtained in this manner, among variables included in M1 and M2, ρ_{Air} and ρ_{HC} are values determined as physical constants and are stored as parts of the equation (24) in the memory of the ECU 800 in this embodiment. Therefore, to compute the concentration D of fuel vapor by the use of the equation (24), among variables included in M1 and M2, the pressure differences ΔP_{Air}, ΔP_{Gas} when air and air-fuel mixture pass through the restrictor 50 and the shutoff pressure Pt of the pump 14 are necessary. Hence, in the above-mentioned concentration measurement processing in the step S102, the pressure differences ΔP_{Air}, ΔP_{Gas} and the shutoff pressure Pt are detected and the concentration D of fuel vapor is computed from these detected values. Hereinafter, the flow of the concentration measurement processing will be described on the basis of FIG. 8. It is assumed that when the concentration measurement processing is carried out, the purge controlling valve 18 and the connection controlling valve 19 are in a closed state, the passage-switching valve 20 is in the first state, and the passage opening/closing valve 21 and the canister closing valve 22 are in the open state.

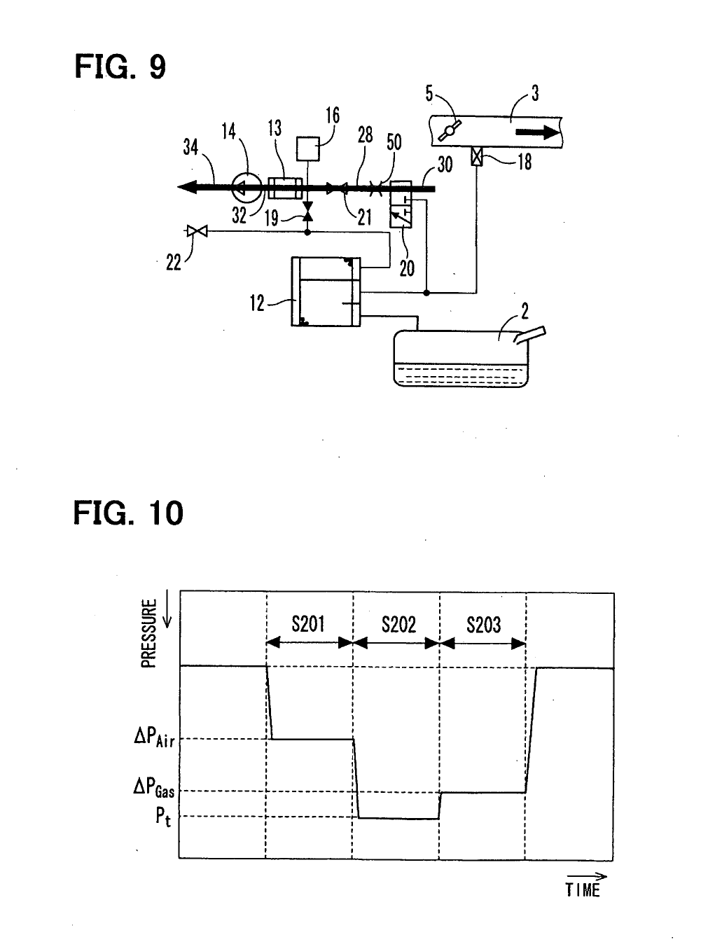

First, in step S201, the pump 14 is driven and controlled to a specified number of revolutions by the ECU 800 to reduce pressure in the second detection passage 32. At this time, the respective valves 18 to 22 are in the same states as the states when the concentration measurement processing is started, as shown in FIG. 5. Hence, as shown in FIG. 9, air flows from the first atmosphere passage 30 into the first detection passage 28 and hence the pressure difference detected by the differential pressure sensor 16 is changed to a specified value ΔP_{Air} as shown in FIG. 10. Then, in this step S201, when the pressure difference detected by the differential pressure sensor 16 becomes stable, the stable value is stored in the memory of the ECU 800 as the pressure difference ΔP_{Air} when air passes. In this step S201, air discharged from the pump 14 to the second discharge passage 34 is dissipated into the atmosphere through the filter 51.

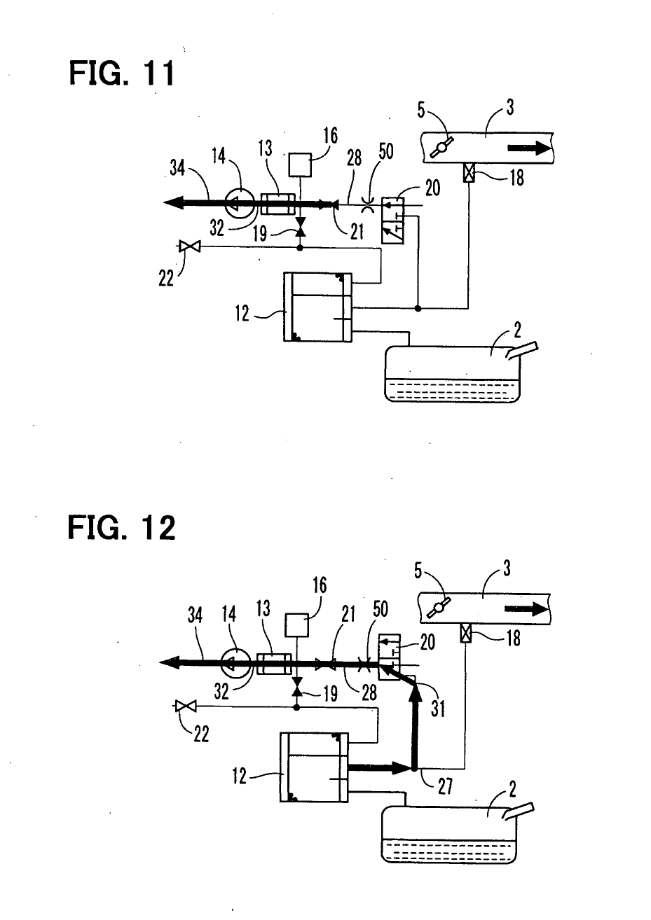

Next, in step S202, while the pump 14 is being driven and controlled to the specified number of revolutions just as with step S201, the passage opening/closing valve 21 is brought to a closed state. With this, the respective valves 18 to 22 are brought into the states shown in FIG. 5 and hence the first detection passage 28 is closed as shown in FIG. 11. The pressure difference detected by the differential pressure sensor 16 is changed to the shutoff pressure Pt of the pump 14 as shown in FIG. 10. Then, in this step S202, when the pressure difference detected by the differential pressure sensor 16 becomes stable, the stable value is stored as the shutoff pressure Pt of the pump 14 in the memory of the ECU 800. In this step S202, air discharged from the pump 14 to the second atmosphere passage 34 by the time when the pressure difference detected by the differential pressure sensor 16 becomes stable is dissipated into the atmosphere through the filter 51.

Successively, in step S203, while the pump 14 is being controlled to the specified number of revolutions just as with step S201, the passage-switching valve 20 is brought into the second state and at the same time the passage opening/closing valve 21 is bought into an open state. With this, the respective valves 18 to 22 are brought into the states shown in FIG. 5 and hence, as shown in FIG. 12, the air-fuel mixture flows from the branch passage 31 of the purge passage 27 into the first detection passage 28, and the pressure difference detected by the differential pressure sensor 16, as shown in FIG. 10, is changed to a value ΔP_{Gas} relating to the concentration D of fuel vapor. In this step S203, when the pressure difference detected by the differential pressure sensor 16 becomes stable, the stable value is stored in the memory of the ECU 800 as the pressure difference ΔP_{Gas} when the air-fuel mixture passes. In this step S203, the fuel vapor in the air-fuel mixture passing through the restrictor 50 does not pass to the second detection passage 32 but is adsorbed by the adsorption part 41. Hence, only air passing through the second canister 13 of the air-fuel mixture reaches the pump 14. Therefore, only air is discharged from the pump 14 and is dissipated into the atmosphere.

In step S204 following step 203, the pump 14 is stopped by the ECU 800. Further, in step S204 in this embodiment, the passage-switching valve 20 is returned to the first state. Thereafter, in step S205, the pressure differences ΔP_{Air} and ΔP_{Gas} stored in steps S201 and S203, the shutoff pressure Pt stored in step S202, and the previously stored equation (24) are read from the memory of the ECU 800 to the CPU. Further, in step S205, the pressure differences ΔP_{Air}, ΔP_{Gas} and the shutoff pressure Pt, which are read, are substituted into the equation (24) to compute the concentration D of fuel vapor and the computed concentration D is stored in the memory.

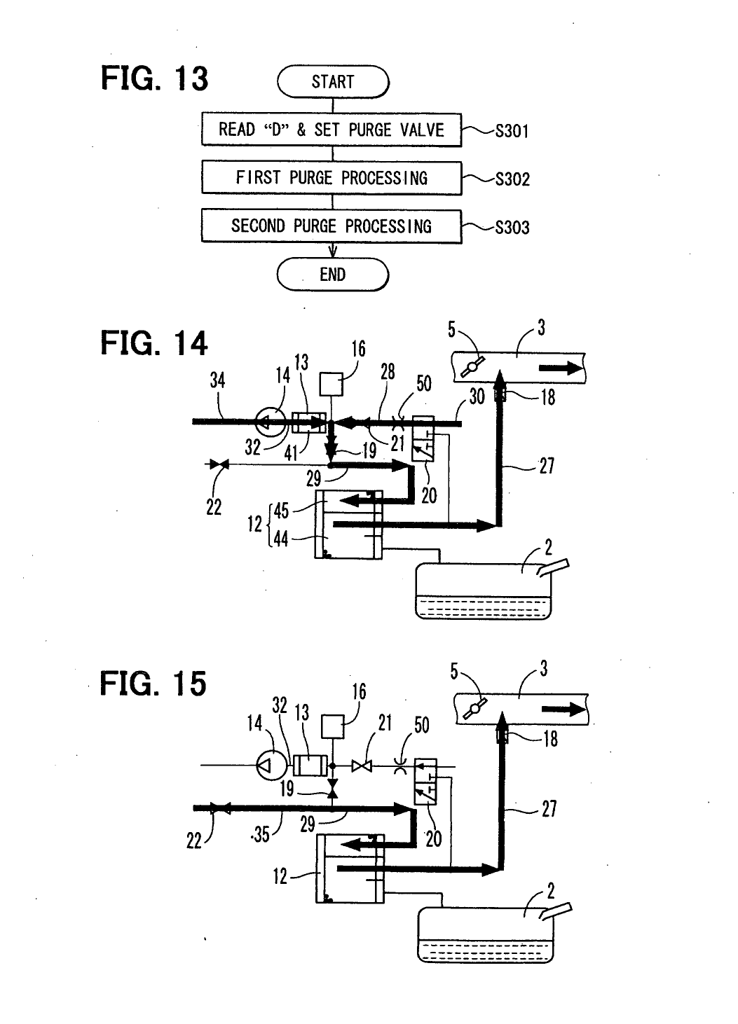

A flow of the purge processing in step S107 will be described on the basis of FIG. 13. When the purge processing is started, the states of the respective valves 18 to 22 are in the states realized in step S204 of the immediately preceding concentration measurement processing. First, in step S301, the computed concentration D stored in the step S205 of the immediately preceding concentration measurement processing is read from the memory of the ECU 800 to the CPU. Further, in step S301, the opening of the purge controlling valve 18 is set on the basis of the vehicle state quantities such as acceleration position of the vehicle and the computed concentration D, which is read, and then the set value is stored in the memory.

Next, in step S302, the ECU 800 brings the purge-controlling valve 18 and the connection controlling valve 19 to an open state and brings the canister-closing valve 22 to a closed state and carries out first purge processing. With this, the valves 18 to 22 are brought into the states shown in FIG. 5 and hence, as shown in FIG. 14, the second detection passage 32 is open to the atmosphere and negative pressure in the intake passage 3 is applied to the elements 27, 12, 29, 28, and 13. Therefore, fuel vapor is desorbed from the main adsorption part 44 and is purged into the intake passage 3. Then, the air-fuel mixture remaining in the first detection passage 28 by the concentration measurement processing flows into the subordinate adsorption part 45 and the fuel vapor in the air-fuel mixture is adsorbed by the subordinate adsorption part 45. Furthermore, because negative pressure is applied to the second canister 13, the fuel vapor is desorbed from the adsorption part 41. Hence, this desorbed fuel vapor also flows into the subordinate adsorption part 45 and is adsorbed there. The first purge processing in step S302 aims to purge the fuel vapor from the second canister 13 in this manner. Then, when it is assumed that the time required to carry out step S203 of the concentration measurement processing is Td, the time required to carry out step S302, that is, the processing time Tp required to carry out the first purge processing is set to Tp≧Td. Because the suction pressure of the pump 14 is smaller than negative pressure in the intake passage 3 in steps S201 to S203 of the concentration measurement processing, the fuel vapor can be sufficiently purged from the second canister 13 by setting the processing time Tp in this manner.

In step S302, the set opening stored in the memory in step S301 is read by the CPU and the opening of the purge controlling valve 18 is controlled in such a way as to coincide with the set opening. In this manner, when the time Tp elapses after step S302 is started, the routine proceeds to the next step S303.

In step S303, the ECU 800 brings the connection controlling valve 19 to a closed state and brings the canister closing valve 22 to an open state to carry out second purge processing. With this, the valves 18 to 22 are brought into the states shown in FIG. 5. Hence, as shown in FIG. 15, the third atmosphere passage 35 and the portion 29b closer to the subordinate adsorption part 45 of the transit passage 29 are opened to the atmosphere and negative pressure in the intake passage 3 is applied to the elements 27, 12. Hence, fuel vapor is desorbed from the main adsorption part 44 and is purged into the intake passage 3. Also in step S303, just as with step S302, the set opening is read and the opening of the purge controlling valve 18 is controlled in such a way as to coincide with the set opening. Moreover, when the purge stop conditions described above are satisfied, the procedure in step S303 is finished.

As long as the capacity of the pump 14 is constant, according to the energy conservation law, the flow velocity is different between the air passing through the first detection passage 28 and the gas passing the first detection passage due to a difference in density thereof. Since the density and the fuel vapor concentration have a relation, the flow velocity is varied according to the fuel vapor concentration.

The flow velocity defines a pressure loss at the restrictor 50. Hence, the fuel vapor concentration of the air-fuel mixture is correctly detected based on a pressure loss of the air passing through the first detection passage 28 in the first state and a pressure loss of the air-fuel mixture passing through the first detection passage 28 in the second state. That is, even when the engine 100 is stopped, the fuel vapor concentration can be correctly detected. Therefore, a frequency of the engine operation for performing the purge processing can be reduced in the hybrid vehicle, whereby the fuel economy is improved.

According to the first embodiment described above, in the concentration measurement processing, the pump 14 reduces pressure in the second detection passage 32 without desorbing fuel vapor from the second canister 13. With this, in step S201 of the concentration measurement processing, air flowing into the first detection passage 28 and passing through the restrictor 50 passes through the second canister 13 and reaches the pump 14. Hence, as shown in FIG. 2, the pressure difference ΔP_{Air} becomes a value expressed by an intersection point of the ΔP-Q characteristic curve C_{Air} of air at the restrictor 50 and the P-Q characteristic curve Cₚₘₚ of the pump 14. In step S203 of the concentration measurement processing, fuel vapor of the air-fuel mixture flowing into the first detection passage 28 and passing through the restrictor 50 is adsorbed by the second canister 13 and hence only air of the air-fuel mixture reaches the pump 14. Hence, when the pressure difference ΔP_{Gas} when a 100% concentration air-fuel mixture passes through the restrictor 50 is thought, the pressure difference ΔP_{Gas} becomes a value equal to the shutoff pressure Pt of the pump 14, as shown in FIG. 3. The pressure difference ΔP_{Gas} when the 100% concentration air-fuel mixture passes through the restrictor 50 becomes large value. The difference between the pressure difference ΔP_{Gas} when the 100% concentration air-fuel mixture passes through the restrictor 50 and the pressure difference ΔP_{Air} when air passes through the restrictor 50, that is, the detection gain G becomes large. For this reason, in this embodiment can be secured a detection gain G that is sufficiently large with respect to the pressure resolution capacity of the differential pressure sensor 16. Therefore, it is possible to improve the relative detection accuracy of the pressure difference ΔP_{Gas} to the pressure difference ΔP_{Air}.

Moreover, according to the embodiment, in the concentration measurement processing, the fuel vapor is adsorbed by the second canister 13 and does not reach the pump 14. Hence, this can prevent the P-Q characteristics of the pump 14 and the pressure difference detected by the differential pressure sensor 16 from being rendered unstable by the pump 14 suctioning the fuel vapor. Further, according to the first embodiment, because the number of revolutions of the pump 14 is controlled to a constant value in the concentration measurement processing, the pressure differences ΔP_{Air}, ΔP_{Gas} and the shutoff pressure Pt can be detected in a state where the P-Q characteristics of the pump 14 are stable. Therefore, it is possible to reduce such detection errors of the pressure differences ΔP_{Air}, ΔP_{Gas} and the shutoff pressure Pt that are caused by changes in the P-Q characteristics of the pump 14.

Moreover, according to the embodiment, the purge controlling valve 18 is closed in step S203 of the concentration measurement processing and hence the air-fuel mixture in the purge passage 27 is surely taken by the first detection passage 28 and the pulsation of negative pressure in the intake passage 3 is not transmitted to the air-fuel mixture flowing into the first detection passage 28. As a result, it is possible to reduce the detection error of the pressure difference ΔP_{Gas} caused by the deficient flow rate of the air-fuel mixture at the restrictor 50 and the transmission of pulsation of negative pressure. In this manner, it is possible to detect the pressure differences ΔP_{Air}, ΔP_{Gas} and the shutoff pressure Pt with accuracy in the concentration measurement processing and hence to improve the computation accuracy of the concentration D of fuel vapor.

Still further, according to the embodiment, as shown in FIG. 10, the shutoff pressure Pt becomes larger on the negative pressure side than the pressure difference ΔP_{Air}. Hence, according to the concentration measurement processing in which the step S202 where the shutoff pressure Pt is detected is performed successively after the step S201 where the pressure difference ΔP_{Air} is detected, the total time of the times required to stabilize the pressure difference detected by the differential pressure sensor 16 in the respective steps S202, S201 can be made shorter than the total time in the case where the step S202 is performed before the step S201. Moreover, in step S202 of the concentration measurement processing, the first detection passage 28 is closed between the restrictor 50 and the second canister 13. This can also make it possible to stabilize the pressure difference detected by the differential pressure sensor 16 within a short time. Still further, in the concentration measurement processing, the pressure difference ΔP_{Gas} is detected in the step S203 after detection of the pressure difference ΔP_{Air} and the shut off pressure Pt. Hence, the air-fuel mixture used for detecting the pressure difference ΔP_{Gas} does not remain in the first detection passage 28 when the pressure difference ΔP_{Air} and the shutoff pressure Pt are detected. Therefore, the time required to stabilize the pressure difference detected by the differential pressure sensor 16 when the pressure difference ΔP_{Air} and the shutoff pressure Pt are detected is not elongated by the air-fuel mixture in the first detection passage 28.

In this manner, according to the embodiment, the steps S201 and S202 of the concentration measurement processing can be carried out within a short time and hence the total time required to carry out the concentration measurement processing can be shortened. With this, time for carrying out the purge processing is increased and the real quantity of purge can be sufficiently secured. Hence, it is possible to avoid a trouble that the fuel vapor is unexpectedly desorbed from the first canister 12.

In addition, according to the embodiment, in the first purge processing carried out after the concentration measurement processing, the purge controlling valve 18 and the connection controlling valve 19 are opened and hence negative pressure in the intake passage 3 is applied to the first detection passage 28 and the second canister 13. With this, the air-fuel mixture remaining in the first detection passage 28 and the fuel vapor desorbed from the second canister 13 by the negative pressure are introduced into the subordinate adsorption part 45 of the first canister 12. That is, the air-fuel mixture and the fuel vapor are purged from the first detection passage 28 and the second canister 13. Hence, it is possible to avoid a trouble that the fuel vapor taken by the first detection passage 28 and the second canister 13 in the preceding concentration measurement processing makes an affect on the following concentration measurement processing. Moreover, the fuel vapor adsorbed by the subordinate adsorption part 45 in the first purge processing reaches the main adsorption part 44 after some period of time because of the existence of the space 48. With this, in the first purge processing, the fuel vapor desorbed from the main adsorption part 44 and introduced into the purge passage 27 is not increased. As a result, it is possible to prevent the real concentration of purge from being deviated from the computed concentration D in the immediately preceding concentration measurement processing.

In addition, according to the first embodiment, after the main operation is finished, the connection-controlling valve 19 is normally brought to a closed state. As a result, it is possible to prevent a trouble that the fuel vapor adsorbed by the subordinate adsorption part 45 in the first purge processing is desorbed after the main operation is finished and reaches the first detection passage 28 and the second canister 13 by mistake. Therefore, it is possible to avoid a trouble that the fuel vapor desorbed from the subordinate adsorption part 45 makes an affect on the following concentration measurement processing.

### Other Embodiment

In the above embodiment, the hybrid vehicle is provided with the electric motor 200 and the alternator 700 independently. The present invention can be applied to a hybrid vehicle which is provided with a motor generator having functions of the motor and the alternator.

What is claimed is:

1. A controller for a hybrid vehicle provided with an electric motor as a driving power source, a secondary battery supplying electricity to the electric motor, an electric generator charging the secondary battery, and an internal combustion engine driving the electric generator, the controller comprising:
a fuel vapor treatment apparatus which temporarily adsorbs fuel vapor generated in a fuel tank by a canister and then supplies an air-fuel mixture including the fuel vapor to the internal combustion engine, and
an engine control means for controlling the internal combustion engine based on a fuel vapor adsorbing state of the canister, wherein
the fuel vapor treatment apparatus includes:
a detection passage provided with an restrictor therein;
a gas-flow producing means for decompressing an interior of the detection passage to generate a gas-flow therein;
a detection passage switching means for switching the detection passage between a first state where the detection passage communicates to atmosphere to introduce air therein and a second state where the detection passage communicates to the canister to introduce the air-fuel mixture therein;
a pressure detecting means for detecting a pressure determined by the restrictor and the gas flow producing means; and
a concentration computing means for computing a fuel vapor concentration of the air-fuel mixture based on a detected pressure in the first state and a detected pressure in the second state, wherein
when the fuel vapor concentration computed by the concentration computing means reaches a specified value, the engine control means starts the internal combustion engine and commands the fuel vapor treatment apparatus to supply the fuel vapor adsorbed by the canister to the internal combustion engine.

2. A controller for a hybrid vehicle according to claim 1, wherein
the fuel vapor treatment apparatus is provided with a start determination means for determining whether a fuel-vapor-concentration computation by the concentration computing means should be started, wherein
the start determination means determines to start the fuel-vapor-concentration computation when an elapse time exceeds a preset time after a last fuel-vapor-concentration computation, and sets the preset time shorter as a last computed fuel vapor concentration becomes larger.
